(19) United States
(12) Patent Application Publication
(10) Pub. No.: US 2014/0099520 A1
(43) Pub. Date: Apr. 10, 2014

(54) Liquid Flow Battery System and Repairing Device Thereof

(71) Applicants: Hao Tang, Chengdu (CN); Cong Yin, Chengdu (CN); Zhankui Zhang, Chengdu (CN); Roggui Wang, Chengdu (CN); Guangyo Xie, Chengdu (CN); Yuncheng Hu, Chengdu (CN)

(72) Inventors: Hao Tang, Chengdu (CN); Cong Yin, Chengdu (CN); Zhankui Zhang, Chengdu (CN); Roggui Wang, Chengdu (CN); Guangyo Xie, Chengdu (CN); Yuncheng Hu, Chengdu (CN)

(73) Assignee: Dongfang Electric Corporation, Chengdu, Sichuan (CN)

(21) Appl. No.: 14/124,271

(22) PCT Filed: Nov. 9, 2011
(86) PCT No.: PCT/CN2011/081988

§ 371 Date: Dec. 6, 2013

(30) Foreign Application Priority Data
Jun. 7, 2011 (CN) 201110151029.6

(51) Int. Cl. H01M 8/06; H01M 8/18; H01M 8/20

(52) U.S. Cl. CPC H01M 8/0693; H01M 8/20; H01M 8/188
USPC 429/49

(57) ABSTRACT

The disclosure discloses a liquid flow battery system and a repairing device thereof. The repairing device, used for cleaning a battery stack of the liquid flow battery system, comprises an acid liquid storage tank (11), configured to store an acid solution; a first acid liquid pipe (12) connected with a first end of the acid liquid storage tank (11), configured to be connected with a first end of the battery stack; a second acid liquid pipe (13) connected with a second end of the acid liquid storage tank (11), configured to be connected with a second end of the battery stack; and a power device (14) arranged in the first acid liquid pipe (12) or the second acid liquid pipe (13) and configured to drive the acid solution in the acid liquid storage tank (11) to flow circularly in the first acid liquid pipe (12) and the second acid liquid pipe (13). Through the disclosure, the liquid flow battery system can be cleaned conveniently and in time, so as to realize the self-repairing of the liquid flow battery, improve the operational efficiency of the liquid flow battery and prolong the service life of the liquid flow battery system.

### TECHNICAL FIELD OF THE INVENTION

The invention relates to the field of liquid flow batteries, in particular, to a liquid flow battery system and a repairing device thereof.

### BACKGROUND OF THE INVENTION

A liquid flow battery which is generally called as a redox liquid flow battery, is a novel large-scale electrochemical energy storage device. The liquid flow battery, of which the anode and cathode both use vanadium salt solution, is called as an all-vanadium redox liquid flow battery. The all-vanadium redox liquid flow battery is an electrochemical reaction device which performs redox (oxidation-reduction) by using vanadium ion electrolyte in different valence states and can realize mutual transformation between chemical energy and electric energy. The battery of such type has advantages of long service life, high energy transformation efficiency, good security, environmental-friendliness and the like, can be applied to large-scale energy storage systems assorted with wind power generation and photovoltaic power generation, and becomes one primary selection for clipping the peak and filling the valley of electric grid as well as load balance. Consequently, the all-vanadium redox liquid flow battery gradually becomes the key point for the research of large-capacity energy storage batteries in recent years.

The all-vanadium redox liquid flow battery respectively regards the vanadium ions V²⁺/V³⁺ and V⁴⁺/V⁵⁺ as redox pair (oxidation-reduction pair) of the anode and cathode of the battery, and respectively stores the anode and cathode electrolytes into two liquid storage tanks; and an acid-proof liquid pump drives the active electrolyte to a reaction field (a battery stack, or called as cell stack) and then drive the electrolyte to return to the liquid storage tank to form a circulation liquid flow loop so as to realize charge and discharge processes. In the energy storage system of the all-vanadium redox flow battery, the performance of the battery stack determines the performance of the charge and discharge of the whole system, in particular the power and efficiency of the charge and discharge. The battery stack is formed by sequentially stacking, tightly pressing a plurality of single batteries in serial connection; the composition of a traditional single liquid flow battery is as shown in a FIG. 1. 1 is a liquid flow frame; 2 is a collector plate, 3 is an electrode; 4 is a diaphragm; all the components compose a single battery 5; and N single batteries 5 are piled up to form a battery stack 6.

A traditional all-vanadium redox liquid flow battery system, as shown in a FIG. 2, is composed of a battery stack 6, an anode liquid storage tank 71, a cathode liquid storage tank 72, a liquid pump 81 of an anode circulation liquid path, a liquid pump 82 of a cathode circulation liquid path, anode liquid pipes 91, 101 and cathode liquid pipes 92, 102. The V⁴⁺/V⁵⁺ electrolyte is conveyed to the anode half battery 61 by the liquid pump 81; and the cathode V²⁺/V³⁺ electrolyte is, conveyed to a cathode half battery 62 by the liquid pump 82. The traditional all-vanadium redox liquid flow battery system, which works for a long time or holds at a high State of Charge (for short, SOC) for a long time or works at abnormal working temperature and the like, may cause the electrolyte to separate precipitates out to block graphite felt, pipes, liquid pumps and the like. Thereby, the charge-discharge efficiency and service life of the battery stack are reduced greatly; and the whole liquid flow battery system may even be resulted in paralysis.

At present, no efficient solution is presented to solve the problems of reducing the performance of the liquid flow battery system rapidly due to said reasons and further causing the reduction of the service life of the liquid flow battery.

### SUMMARY OF THE INVENTION

The main purpose of the invention is to provide a liquid flow battery system and a repairing device thereof to solve the problems of reducing the performance of the liquid flow battery system rapidly and further causing the reduction of the service life of the liquid flow battery.

In order to realize the purpose and in accordance with one aspect of the invention, a repairing device of the liquid flow battery system is provided.

The repairing device of the liquid flow battery system according to the invention, which is configured to clean a battery stack of the liquid flow battery system, comprising: an acid liquid storage tank, configured to store an acid solution; a first acid liquid pipe, wherein a first end of the first acid liquid pipe is connected with a first end of the acid liquid storage tank, and a second end of the first acid liquid pipe is configured to be connected with a first end of the battery stack; a second acid liquid pipe, wherein a first end of the second acid liquid pipe is connected with a second end of the acid liquid storage tank, and a second end of the second acid liquid pipe is configured to be connected with a second end of the battery stack; and a power device, arranged in the first acid liquid pipe or the second acid liquid pipe and configured to drive the acid solution in the acid liquid storage tank to flow circularly in the first acid liquid pipe and the second acid liquid pipe.

Furthermore, the liquid flow battery system comprises: an electrolyte storage tank; a first electrolyte pipe, connected between a first end of the electrolyte storage tank and the first end of the battery stack; and a second electrolyte pipe, connected between a second end of the electrolyte storage tank and the second end of the battery stack, wherein the second end of the first acid liquid pipe is configured to be connected into the first electrolyte pipe; and the second end of the second acid liquid pipe is configured to be connected into the second electrolyte pipe.

Furthermore, the repairing device of the liquid flow battery system comprises a first branching valve and a second branching valve, wherein the second end of the first acid liquid pipe is configured to be connected with the first electrolyte pipe through the first branching valve; the second end of the second acid liquid pipe is configured to be connected with the second electrolyte pipe through the second branching valve; the first branching valve and the second branching valve both have a first position and a second position; when the first branching valve and the second branching valve are located at the first position at the same time, the acid liquid storage tank connects with the battery stack to form a circulation pipe; and when the first branching valve and the second branching valve are located at the second position at the same time, the electrolyte storage tank connects with the battery stack to form a circulation pipe.

Furthermore, the acid solution is dilute acid.

Furthermore, the repairing device of the liquid flow battery system comprises: a liquid flow battery monitoring device, configured to judge whether it is required to clean the battery stack of the liquid flow battery system; and a control device, configured to control the power device to drive the acid solution in the acid liquid storage tank to flow circularly in the first acid liquid pipe and the second acid liquid pipe when it is determined that it is required to clean the battery stack of the liquid flow battery system.

Furthermore, the liquid flow battery monitoring device is configured to monitor a first curve which is a curve of a relationship between the consumption power of a liquid pump of the liquid flow battery system and the output pressure intensity of the liquid pump; compare the first curve with a first standard curve, wherein the first standard curve is a preset standard curve of the relationship between the consumption power of the liquid pump of the liquid flow battery system and the output pressure intensity of the liquid pump; and judge whether the battery stack of the liquid flow battery system is required to be cleaned according to the result of comparing the first curve with the first standard curve.

Furthermore, the liquid flow battery monitoring device is configured to monitor a second curve which is a curve of a relationship between the voltage of the liquid flow battery system and the State of Charge (SOC) of the battery stack; compare the second curve with a second standard curve, wherein the second standard curve is a preset standard curve of a relationship between the voltage of the liquid flow battery system and the SOC of the battery stack; and judge whether the battery stack of the liquid flow battery system is required to be cleaned according to the result of comparing the second curve with the second standard curve.

Furthermore, the liquid flow battery monitoring device is configured to monitor a voltage of a single battery of the battery stack of the liquid flow battery system, wherein the battery stack includes a plurality of single batteries; compare the voltage of the single battery with a preset standard voltage of the single battery; and judge whether the battery stack of the liquid flow battery system is required to be cleaned according to the result of comparing the voltage of the single battery and the preset standard voltage of the single battery.

According to the other aspect of the invention, a liquid flow battery system comprising the repairing device of the liquid flow battery is provided.

Furthermore, the liquid flow battery system is an all-vanadium redox liquid flow battery system.

Furthermore, the liquid flow battery system comprises: a first liquid flow battery repairing device, configured to clean an anode half battery stack of the liquid flow battery system; and a second liquid flow battery repairing device, configured to clean a cathode half battery stack of the liquid flow battery system.

Through the invention, the repairing device of the liquid flow battery comprising the following components is adopted: an acid liquid storage tank, configured to store an acid solution; a first acid liquid pipe, connected with a first end of the acid liquid storage tank, configured to be connected with a first end of the battery stack; a second acid liquid pipe, connected with a second end of the acid liquid storage tank, configured to be connected with a second end of the battery stack; and a power device arranged in the first acid liquid pipe or the second acid liquid pipe and configured to drive the acid solution in the acid liquid storage tank to flow circularly in the first acid liquid pipe and the second acid liquid pipe. The problems of reducing the performance of the liquid flow battery system rapidly and further causing the reduction of the service life of the liquid flow battery are solved, so as to render the effects of improving the operational efficiency of the liquid flow battery and prolonging the service life of the liquid flow battery system.

### BRIEF DESCRIPTION OF THE DRAWINGS

Accompanying drawings constituting a portion of the application are provided for the further understanding of the invention; and schematic embodiments and illustrations of the invention are used for explaining the invention, but not consisting improper limitation to the invention. In the accompanying drawings:

FIG. 1 shows a schematic diagram of a single liquid flow battery of an all-vanadium redox liquid flow battery based on traditional art;

FIG. 2 shows a schematic diagram of an all-vanadium redox liquid flow battery system based on traditional art;

FIG. 3 shows a schematic diagram of a repairing device of a liquid flow battery system according to a first embodiment of the invention;

FIG. 4 shows a schematic diagram of a repairing device of a liquid flow battery system according to a second embodiment of the invention; and

FIG. 5 shows a schematic diagram of a repairing device of a liquid flow battery system according to a third embodiment of the invention.

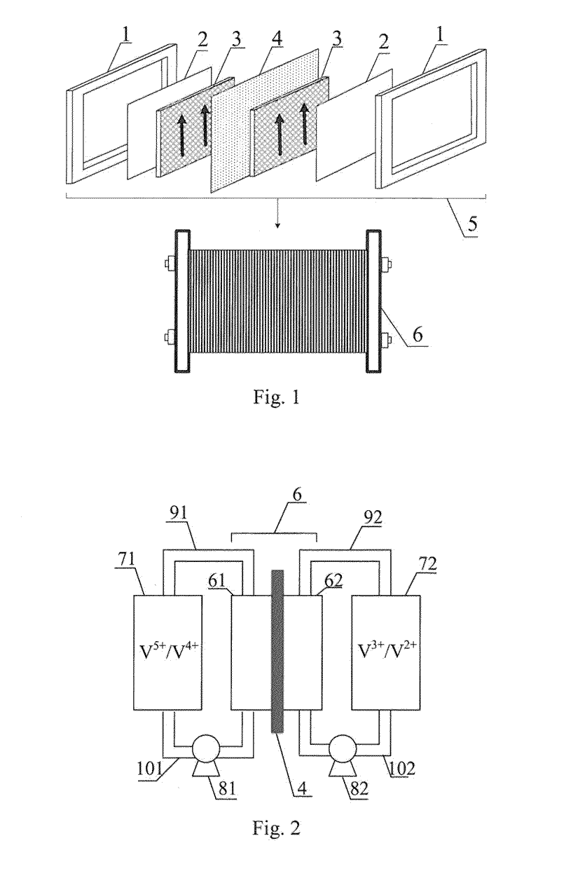

### DETAILED DESCRIPTION OF THE INVENTION

What should be clarified is that the embodiments in the invention and the characteristics in the embodiments can be combined mutually in case of no conflict. The invention is further described below with reference to the accompanying drawings and embodiments in detail.

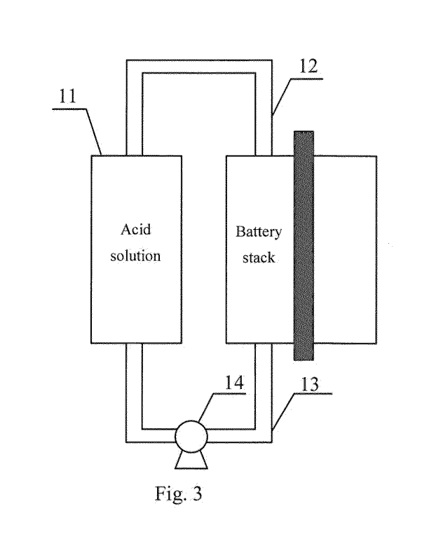

FIG. 3 shows a schematic diagram of a repairing device of a liquid flow battery system according to a first embodiment of the invention. As shown in the FIG. 3, the repairing device of the liquid flow battery system for cleaning the battery stack of the liquid flow battery system comprises: an acid liquid storage tank 11, configured to store acid solution; a first acid liquid pipe 12, wherein a first end of the first acid liquid pipe 12 is connected with a first end of the acid liquid storage tank 11, and a second end of the first acid liquid pipe 12 is configured to be connected with a first end of the battery stack; a second acid liquid pipe 13, wherein a first end of the second acid liquid pipe 13 is connected with a second end of the acid liquid storage tank 11, and a second end of the second acid liquid pipe 13 is configured to be connected with a second end of the battery stack; and a power device 14 arranged in the first acid liquid pipe 12 or the second acid liquid pipe 13 and configured to drive the acid solution in the acid liquid storage tank 11 to flow circularly in the first acid liquid pipe 12 and the second acid liquid pipe 13.

In the liquid flow battery system, since the precipitates separated out from the electrolyte easily leads to block the battery stack, and the battery stack is a key factor for impacting the performance of the liquid flow battery system, so the invention adopts a simple device to wash and re-dissolve the precipitates separated out from the electrode through the acid solution so as to clean the battery stack in time. The specially produced acid solution storage tank is adopted to store the acid solution for cleaning the liquid flow battery system so as to prevent the storage tank from being corroded by the acid solution; a specifically produced acid liquid pipe is adopted for guiding the of the acid solution and making the acid solution circulated; and a power device is set to drive the acid solution to circulate in the loop formed by the acid liquid storage tank, the acid liquid pipe and the battery stack. Therefore, not only the acid solution is saved, but the cleaning effect of the battery stack is also enhanced.

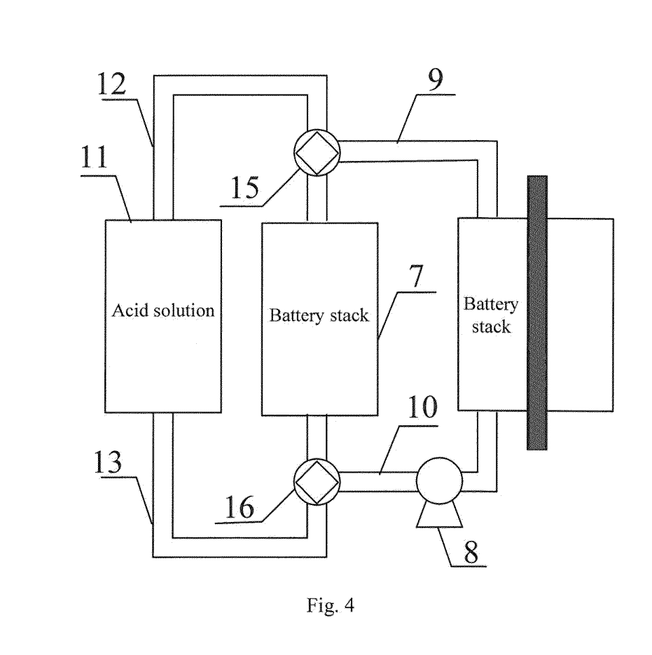

FIG. 4 shows a schematic diagram of a repairing device of a liquid flow battery system according to a second embodiment of the invention. As shown in the FIG. 4, the liquid flow battery system comprises: an electrolyte storage tank 7; a first electrolyte pipe 9 connected between a first end of the electrolyte storage tank 7 and a first end of the battery stack; and a second electrolyte pipe 10 connected between a second end of the electrolyte storage tank 7 and a second end of the battery stack, wherein the first acid liquid pipe 12 is configured to be connected into the first electrolyte pipe 9; and the second acid liquid pipe 13 is configured to be connected into the second electrolyte pipe 10.

In the embodiment, as the acid liquid pipe is connected into the electrolyte pipe, both the battery stack and the electrolyte pipe can be cleaned; meanwhile, the pipe cost is also saved.

Preferably, the repairing device of the liquid flow battery system comprises a first branching valve 15 and a second branching valve 16, wherein the first acid liquid pipe 12 is configured to be connected with the first electrolyte pipe 9 through the first branching valve 15; the second acid liquid pipe 13 is configured to be connected with the second electrolyte pipe 10 through the second branching valve 16; the first branching valve 15 and the second branching valve 16 both have a first position and a second position; when the first branching valve 15 and the second branching valve 16 are located at the first position at the same time, the acid liquid storage tank 11 connects with the battery stack to form a circulation pipe; and when the first branching valve 15 and the second branching valve 16 are located at the second position at the same time, the electrolyte storage tank 7 connects with the battery stack to form a circulation pipe.

In the embodiment, when the repairing device of the liquid flow battery system is fixed in the liquid flow battery system for a long time, a branching valve is arranged at the joint of the electrolyte pipe and the acid liquid pipe. By the arrangement of the branching valve, it is made more convenience that the liquid flow battery system switches between the charge and discharge mode and the cleaning mode. When the two branching valves are located at the first position at the same time, the charge and discharge loop is turned off, and the liquid flow battery system is at the cleaning mode; and when the two branching valves are located at the second position at the same time, the cleaning loop is turned off, and the liquid flow battery system is at the charge and discharge mode.

What should be clarified is as follows: the first branching valve 15 and the second branching valve 16 in the embodiment must be located at the first position or the second position at the same time; when a power device, such as the electrolyte liquid pump 8, is arranged in the charge and discharge loop of the liquid flow battery system, the power device 14 in the repairing device can be removed for the sake of saving cost; and the functions of the power device are realized by the power device of the liquid flow battery system. In addition, the embodiment shows the situation that the repairing device is only arranged at the anode half battery stack of the liquid flow battery system; and it needs to be explained that the repairing device also can be only arranged at the cathode half battery stack of the liquid flow battery system.

Preferably, the acid solution is dilute acid.

Further preferably, the dilute acid is dilute sulphuric acid at the concentration range from 0.1 mol/L to 8 mol/L, and preferably, from 0.8 mol/L to 5 mol/L.

The embodiment of the invention has no limitation to special acid solutions and concentrations; and according to the requirements of the embodiment of the invention, the acid solution can be any inorganic acid or organic acid without strong oxidizing property. The way of adding the acid solution of the repairing device can be various methods and optimized methods obtained with reference to the mastered basic knowledge by the technicians in this field.

The acid solution mentioned in the embodiment of the invention includes but not limited to: hydrochloric acid, phosphoric acid, hydrobromic acid, benzene sulfonic acid, oxalic acid and the like. Preferably, the used dilute acid is as same as the supporting liquid of the electrolyte in the liquid flow battery.

Preferably, the repairing device of the liquid flow battery system comprises: a liquid flow battery monitoring device, configured to judge whether it is required to clean the battery stack of the liquid flow battery system; and a control device, configured to control the power device 14 to drive the acid solution in the acid liquid storage tank 11 to flow circularly in the first acid liquid pipe 12 and the second acid liquid pipe 13 when it is judged that it is required to clean the battery stack of the liquid flow battery system.

In order to estimate health condition of the liquid flow battery system in time and repair the battery system to further improve the charge and discharge performances and the service life, a liquid flow battery monitoring device is added in the repairing device of the liquid flow battery system. The monitoring device can monitor various important parameters of the liquid flow battery in real time to comprehensively estimate the health condition of the battery system. Meanwhile, the control device is set to control the power device to drive the acid solution to flow circularly among the acid liquid storage tank, the acid liquid pipe and the battery stack when the liquid flow battery monitoring device determines the liquid flow battery system is required to be cleaned. The liquid flow battery system which adopts the repairing device of the embodiment realizes the real-time monitoring and estimation of the health condition of the liquid flow battery and can repair the battery stack by itself according to the monitoring and estimation results.

Preferably, the liquid flow battery monitoring device is configured to: monitor a first curve which is a curve of a relationship between the consumption power of the liquid pump of the liquid flow battery system and the output pressure intensity of the liquid pump; compare the first curve with a first standard curve, wherein the first standard curve is a preset standard curve of the relationship between the consumption power of the liquid pump of the liquid flow battery system and the output pressure intensity of the liquid pump; and judge whether the battery stack of the liquid flow battery system is required to be cleaned according to the result of comparing the first curve with the first standard curve.

In the embodiment, the liquid flow battery monitoring device monitors the relationship between the consumption power of the liquid pump of the liquid flow battery system and the output pressure intensity, tests out the standard curve of the consumption power and the output pressure intensity of the liquid pump at various flow speeds when the performance of the battery stack is good, monitors the parameters, such as the consumption power and the output pressure intensity of the liquid pump and the like in real time during the charge and discharge process of the liquid flow battery system, and compares the parameters with that of the standard curve to judge the liquid flow damping condition inside the battery stack and the pipe.

Preferably, the liquid flow battery monitoring device is configured to: monitor a second curve which is a curve of a relationship between the voltage of the liquid flow battery system and the state of charge (SOC) of the battery stack; compare the second curve with a second standard curve, wherein the second standard curve is a preset standard curve of a relationship between the voltage of the liquid flow battery system and the state of charge of the battery stack; and judge whether the battery stack of the liquid flow battery system is required to be cleaned according to the result of comparing the second curve with the second standard curve.

In the embodiment, the liquid flow battery monitoring device monitors the charge and discharge polarization curve of the liquid flow battery system. The liquid flow battery monitoring device tests out the relationship between the charge and discharge voltages and the SOC at various liquid flow speed to be as the reference standard when the performance of the battery stack is good.

Preferably, the liquid flow battery monitoring device is configured to: monitor a voltage of a single battery of the battery stack of the liquid flow battery system, wherein the battery stack includes a plurality of single batteries; compare the voltage of the single battery with a preset standard voltage of the single battery; and judge whether the battery stack of the liquid flow battery system is required to be cleaned according to the result of comparing the voltage of the single battery with the preset standard voltage of the single battery.

In the embodiment, the liquid flow battery monitoring device monitors the voltage of each single battery of the battery stack of the liquid flow battery system, and can compare the voltage of each single battery with the standard voltage of single battery under the condition of good performance of the battery stack during the charge and discharge processes of the liquid flow battery system, and also can monitor the charge and discharge voltages of each single battery inside the battery stack in real time, make a transverse comparison among the single batteries and estimate the relative health condition of each single battery of the battery stack.

When the various parameters are monitored to judge whether the battery stack of the liquid flow battery system is required to be cleaned in the embodiments, a failure determination value is determined through comparing it with the standard parameter; each failure determination value is chosen to be as 40-150% of the initial value according to different types of parameters. The type of the monitoring parameters can be one or more of the above parameters.

According to the other aspect of the invention, a liquid flow battery system comprising above liquid flow battery repairing device is provided.

Preferably, the liquid flow battery system is an all-vanadium redox liquid flow battery system.

In the embodiment, by equipping with a set of externally connected liquid flow battery repairing device, the all-vanadium redox liquid flow battery system has a self-repairing function; under the conditions that the charge and discharge performances of the battery drops, or the consumption of the liquid pump increases sharply, or the performance of one single battery drops sharply and etc, the battery stack and the circular liquid pipe are cleaned in time by washing and re-dissolving the precipitates separated out from the battery stack or the pipe through the acid solution.

Preferably, the liquid flow battery system comprises: a first liquid flow battery repairing device, configured to clean the anode half battery stack of the liquid flow battery system; and a second liquid flow battery repairing device, configured to clean the cathode half battery stack of the liquid flow battery system.

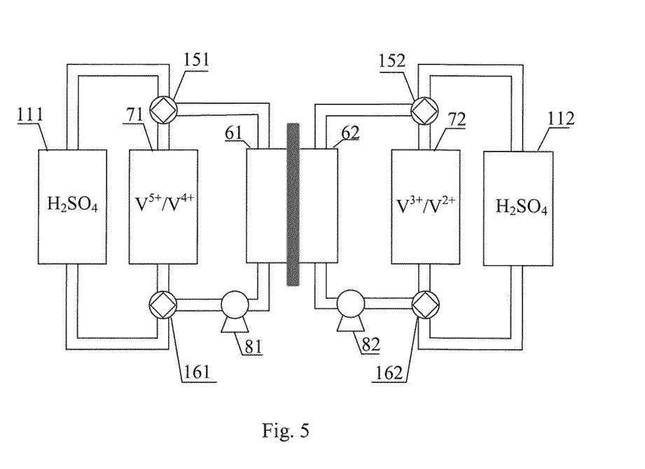

FIG. 5 shows a schematic diagram of a repairing device of a liquid flow battery system according to a third embodiment of the invention. As shown in the FIG. 5, a set of externally connected repairing device of the liquid flow battery system is respectively equipped for the anode liquid path circulation and the cathode liquid path circulation on the basis of the traditional all-vanadium redox liquid flow battery system. The anode liquid pipe (or called as anode liquid path pipe) firstly passes through the branching valve 151 and 161 via the anode half battery 61, and then enters into the anode electrolyte storage tank 71 or the anode acid solution storage tank 111, wherein the pipe selection of the branching valve includes a charge and discharge gear and a dilute acid cleaning gear, and the pipe selection of the branching valves 151 and 161 must be in consistence. The cathode liquid pipe (or called as cathode liquid path pipe) firstly passes through the branching valve 152 and 162 via the cathode half battery 62, and then enters into the cathode electrolyte storage tank 72 or the cathode acid solution storage tank 112, wherein the pipe selection of the branching valves includes a charge and discharge gear and a dilute acid cleaning gear, and the pipe selection of the branching valve 152 and 162 must be in consistence. When the liquid flow battery system selects the charge and discharge gear, the four branching valves 151, 161, 152 and 162 must be at the charge and discharge gear at the same time to ensure that the anode electrolyte storage tank 71 and cathode electrolyte storage tank 72 can be connected into the whole liquid path circulation system; when the liquid flow battery system selects the cleaning gear, the four branching valves 151, 161, 152 and 162 must be at the cleaning gear at the same time to ensure that the anode acid solution storage tank 111 and cathode acid solution storage tank 112 can be connected into the whole liquid path circulation system. The cleaning gear can be switched manually or automatically. Better effects can be obtained if the acid solution used in the repairing device of the liquid flow battery system is sulphuric acid.

Through the technical solution provided by the embodiment of the invention, the liquid flow battery system can be cleaned conveniently and in time to realize the self-repairing of the liquid flow battery, improve the operational efficiency of the liquid flow battery and prolong the service life of the liquid flow battery system.

The all-vanadium redox liquid flow battery system with self-repairing function is designed by adopting the technical proposal of the invention, which are as follows for example:

### Example 1

preparation of the ail-vanadium redox liquid flow battery system with self-repairing function. Porous graphite felt with high conductivity is selected as an electrode material; a graphite plate serves as a collector plate; and a Nafion membrane serves as an ion exchange membrane. A single battery made of above materials has a charge and discharge coulombic efficiency of 90.5%, a voltage efficiency of 88.0%, and an energy efficiency of 79.6%. The battery system with self-repairing function is formed by connecting the single battery into the repairing device according to the method of the invention. After the battery is charged and discharged circularly for 500 times, the charge and discharge coulombic efficiency of the single battery is dropped to 82.1%, the voltage efficiency is dropped to 72.4%, and the energy efficiency is dropped to 59.4%; then the single battery is cleaned by starting and entering into the cleaning program. The battery which has been cleaned has the charge and discharge coulombic efficiency of 88.7%, the voltage efficiency of 87.4% and the energy efficiency of 77.5%.

### Example 2

preparation of the all-vanadium redox liquid flow battery system with self-repairing function. Porous graphite felt with high conductivity is selected as an electrode material; a graphite plate serves as a collector plate; and a Nafion membrane serves as an ion exchange membrane. 15 single batteries each of which is made of above materials compose a battery pack. The battery pack has a charge and discharge coulombic efficiency of 89.8%, a voltage efficiency of 86.4%, and an energy efficiency of 77.6%. The battery system with the self-repairing function is formed by connecting the battery pack into the repairing device according to the method of the invention. After the battery pack is charged and discharged circularly for 500 times, the charge and discharge coulombic efficiency of the battery pack is dropped to 80.3%, the voltage efficiency is dropped to 69.9%, and the energy efficiency is dropped to 56.1%. Then the battery pack is cleaned by starting and entering into the cleaning program. The battery pack which has been cleaned has the charge and discharge coulombic efficiency of 88.4%, the voltage efficiency of 85.9% and the energy efficiency of 75.9%.

### Example 3

preparation of the all-vanadium redox liquid flow battery system with self-repairing function. Porous graphite felt with high conductivity is selected as an electrode material; a graphite plate serves as a collector plate; and a Nafion membrane serves as an ion exchange membrane. 15 single batteries each of which is made of above materials compose a battery pack. The battery pack has a charge and discharge coulombic efficiency of 89.8%, a voltage efficiency of 86.4% and an energy efficiency of 77.6%. The battery system with the self-repairing function is formed by connecting the battery pack into the repairing device according to the method of the invention. The operational state of the battery pack is determined by monitoring the voltage efficiency of the battery pack. Herein, in the case that the voltage efficiency is dropped to 60% of the initial efficiency, the cleaning program is started and performed for the cleaning the battery pack. The battery pack which has been cleaned has the charge and discharge coulombic efficiency of 86.4%, the voltage efficiency of 85.3% and the energy efficiency of 731%.

It can be seen from above description that the invention realizes the following technical effects: the health condition of the liquid flow battery system can be known through monitoring the various important parameter indexes of the liquid flow battery system in real time. When the performance of the liquid flow battery system drops to a certain degree, the self-repairing process can be performed in time through the externally connected acid solution path device; that is to say, the liquid flow battery system is cleaned to prevent the electrodes or the pipes from being totally blocked by the electrolyte educts and improve the charge-discharge efficiency and service life.

The above is only the preferred embodiment of the invention and not intended to limit the scope of protection of the invention. For technicians in the field, the invention may have various changes and modifications. Any modifications, equivalent replacements, improvements and the like within the spirit and principle of the invention shall fall within the scope of protection of the invention.

1. A repairing device of a liquid flow battery system, which is configured to clean a battery stack of the liquid flow battery system, comprising:
an acid liquid storage tank (11), configured to stare an acid solution;
a first acid liquid pipe (12), wherein a first end of the first acid liquid pipe (12) is connected with a first end of the acid liquid storage tank (11), and a second end of the first acid liquid pipe (12) is configured to be connected with a first end of the battery stack;
a second acid liquid pipe (13), wherein a first end of the second acid liquid pipe (13) is connected with a second end of the acid liquid storage tank (11), and a second end of the second acid liquid pipe (13) is configured to be connected with a second end of the battery stack; and
a power device (14), arranged in the first acid liquid pipe (12) or the second acid liquid pipe (13) and configured to drive the acid solution in the acid liquid storage tank (11) to flow circularly in the first acid liquid pipe (12) and the second acid liquid pipe (13).

2. The repairing device of the liquid flow battery system according to claim 1, wherein the liquid flow battery system comprises:
an electrolyte storage tank (7);
a first electrolyte pipe (9), connected between a first end of the electrolyte storage tank (7) and the first end of the battery stack; and
a second electrolyte pipe (10), connected between a second end of the electrolyte storage tank (7) and the second end of the battery stack,
wherein the second end of the first acid liquid pipe (12) is configured to be connected into the first electrolyte pipe (9); and the second end of the second acid liquid pipe (13) is configured to be connected into the second electrolyte pipe (10).

3. The repairing device of the liquid flow battery system according to claim 2, further comprising a first branching valve (15) and a second branching valve (16), wherein
the second end of the first acid liquid pipe (12) is configured to be connected with the first electrolyte pipe (9) through the first branching valve (15);
the second end of the second acid liquid pipe (13) is configured to be connected with the second electrolyte pipe (10) through the second branching valve (16);
the first branching valve (15) and the second branching valve (16) both have a first position and a second position; when the first branching valve (15) and the second branching valve (16) are located at the first position at the same time, the acid liquid storage tank (11) connects with the battery stack to form a circulation pipe; and when the first branching valve (15) and the second branching valve (16) are located at the second position at the same time, the electrolyte storage tank (7) connects with the battery stack to form a circulation pipe.

4. The repairing device of the liquid flow battery system according to claim 1, wherein the acid solution is dilute acid.

5. The repairing device of the liquid flow battery system according to claim 1, further comprising:
a liquid flow battery monitoring device, configured to judge whether it is required to clean the battery stack of the liquid flow battery system; and
a control device, configured to control the power device to drive the acid solution in the acid liquid storage tank (11) to flow circularly in the first acid liquid pipe (12) and the second acid liquid pipe (13) when it is determined that it is required to clean the battery stack of the liquid flow battery system.

6. The repairing device of the liquid flow battery system according to claim 5, wherein the liquid flow battery monitoring device is configured to
monitor a first curve which is a curve of a relationship between the consumption power of a liquid pump of the liquid flow battery system and the output pressure intensity of the liquid pump;
compare the first curve with a first standard curve, wherein the first standard curve is a preset standard curve of the relationship between the consumption power of the liquid pump of the liquid flow battery system and the output pressure intensity of the liquid pump; and
judge whether the battery stack of the liquid flow battery system is required to be cleaned according to the result of comparing the first curve with the first standard curve.

7. The repairing device of the liquid flow battery system according to claim 5, wherein the liquid flow battery monitoring device is configured to
monitor a second curve which is a curve of a relationship between the voltage of the liquid flow battery system and the State of Charge (SOC) of the battery stack;
compare the second curve with a second standard curve, wherein the second standard curve is a preset standard curve of a relationship between the voltage of the liquid flow battery system and the SOC of the battery stack; and
judge whether the battery stack of the liquid flow battery system is required to be cleaned according to the result of comparing the second curve with the second standard curve.

8. The repairing device of the liquid flow battery system according to claim 5, wherein the liquid flow battery monitoring device is configured to
monitor a voltage of a single battery of the battery stack of the liquid flow battery system, wherein the battery stack includes a plurality of single batteries;
compare the voltage of the single battery with a preset standard voltage of the single battery; and
judge whether the battery stack of the liquid flow battery system is required to be cleaned according to the result of comparing the voltage of the single battery and the preset standard voltage of the single battery.

9. A liquid flow battery system, comprising the repairing device of the liquid flow battery according to claim 1.

10. The liquid flow battery system according to claim 9, wherein the liquid flow battery system is an all-vanadium redox liquid flow battery system.

11. The liquid flow battery system according to claim 9, wherein the liquid flow battery repairing device comprises:
a first liquid flow battery repairing device, configured to clean an anode half battery stack of the liquid flow battery system; and
a second liquid flow battery repairing device, configured to clean a cathode half battery stack of the liquid flow battery system.

12. A liquid flow battery system, comprising the repairing device of the liquid flow battery according to claim 2.

13. A liquid flow battery system, comprising the repairing device of the liquid flow battery according to claim 3.

14. A liquid flow battery system, comprising the repairing device of the liquid flow battery according to claim 4.

15. A liquid flow battery system, comprising the repairing device of the liquid flow battery according to claim 5.

16. A liquid flow battery system, comprising the repairing device of the liquid flow battery according to claim 6.

17. A liquid flow battery system, comprising the repairing device of the liquid flow battery according to claim 7.

18. A liquid flow battery system, comprising the repairing device of the liquid flow battery according to claim 8.

19. The liquid flow battery system according to claim 12, wherein the liquid flow battery system is an all-vanadium redox liquid flow battery system.

20. The liquid flow battery system according to claim 13, wherein the liquid flow battery system is an all-vanadium redox liquid flow battery system.
